(19) United States
(12) Patent Application Publication
(10) Pub. No.: US 2010/0088223 A1
(43) Pub. Date: Apr. 8, 2010

(54) Preauthorized Electronic Fund Transfer For Future Cash Advances

(76) Inventor: Dick Carle, Huntington Beach, CA (US)

Correspondence Address: FISH & ASSOCIATES, PC;ROBERT D. FISH, 2603 Main Street, Suite 1000, Irvine, CA, 92614-6232, US

(21) Appl. No.: 12/574,038

(22) Filed: Oct. 6, 2009

Related U.S. Application Data
(60) Provisional application No. 61/103,001, filed on Oct. 6, 2008.

(51) Int. Cl. G06Q 40/00; G06Q 20/00; G06Q 10/00

(52) U.S. Cl. 705/38

(57) ABSTRACT

Methods of providing a loan are presented. Short term loans (e.g., payday loans) can not be rolled over automatically. Still, a roll over of a short term loan can be simulated. A lender server can be configured to provide a new loan application to a borrower. The borrower can submit the new loan application along with an electronic signature representing an authorization for one or more electronic fund transfers to payback the initial loan or to deposit new funds, less possible applicable fees, into an account of the borrower. Furthermore, the initial loan can be paid back by coordinating a payroll deduction with the employer of the borrower.

This application claims the benefit of priority to U.S. provisional application having Ser. No. 61/103,001 filed Oct. 6, 2008. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is electronic fund transfer technologies.

### BACKGROUND

Short terms loans are offered through various lenders to help borrowers obtain a small amount of money (e.g., less than $500). Such loans are required to be paid back quickly, on or before the borrower's next payday. Often the borrower's employer deducts a payback amount from the borrower's paycheck and transfers the money to the lender. Example short term loans include payday loans or cash advances.

Lenders, borrowers, or even the borrower's employer utilize Electronic Fund Transfers (EFTs) to transfer money among accounts once proper authorization has been given. For example, once a borrower requests a loan for $300, a lender performs an EFT to transfer funds to the borrower's account. Upon payday, the borrower's employer can deduct funds from the borrower's pay check and could perform an EFT to transfer funds back to the lender to cover the loan and to cover possible finance charges.

Unfortunately, payday loans or other short term loans have numerous issues, many of which are due to various regulations. One issue includes that the short term loans must be paid back quickly by the next pay check (e.g., within 31 days). Another issue, resulting from the first issue, is that a borrower can not roll over such a short term loan. Should a borrower wish to roll over the loan, the borrower is left few or no options.

Others have attempted to address various issues with short term loans. For example, U.S. Pat. No. 7,386,507 to Davis et al. titled “Loan Program and Process for Transacting the Same”, filed on Sep. 21, 2007, describes a loan program where payments for a payday loan are adjusted to ensure that the annual percentage rate for the loan remains at or below regulated limits. Davis basically provides for supporting a longer term loan as opposed to a short term loan. Although, Davis addresses one of the many regulatory issues, Davis fails to address other issues including providing a roll over mechanism for borrowers.

What has yet to be appreciated is that borrowers can quickly obtain a second loan in a manner that offers the benefit of a roll over. Once a borrower obtains a first loan, the borrower can fill out a new loan application for a second loan where the borrower uses an electronic signature to complete the new loan application, possibly including a pre-authorization for an EFT. The new loan application or EFT authorization can be submitted before payback of the initial loan. When the first loan is due, the borrower pays back the loan in full (e.g., a loan amount and/or possible finance changes). After which, subject to approval or acceptance of the new application, the lender can transfer the amount for the second loan to an account designated by the borrower. Such an approach allows a borrower to effectively roll over a short term loan quick while ensuring compliance with applicable laws.

Thus, there is still a need for methods of providing a loan.

### SUMMARY OF THE INVENTION

The inventive subject matter provides apparatus, systems and methods in which one or more short term loans can be provided to a borrower to simulate rolling over a previous loan. For example, a payday loan can be provided quickly after submitted an electronic signature to authorize one or more electronic fund transfers.

One aspect of the inventive subject matter includes a method for providing a loan through a computer system. A lender server, preferably operated by a loan lender, is configured to authorize a first loan to a borrower. An amount of money corresponding to the first loan can be deposited into an account indicated the borrower. Preferably the first loan corresponds to a short term loan having a term of no more than 31 days. Furthermore, a preferred loan has a corresponding amount of money of no more than $500, and more preferably no more than $300. To roll over a loan, the lender server can configure a borrower interface to present a new loan application to the borrower where the new loan application includes an electronic signature block. A borrower can enter an electronic signature into the new loan application via the borrower interface and electronic submit the application back to the lender for approval. In a preferred embodiment, the electronic signature is obtained before a payback amount for the first loan is provided back to the lender. The lender can receive the payback amount as authorized by the borrower, possibly obtained from an employer of the borrower, possibly resulting from a payroll deduction. A second amount of money from the new loan, less possible fees, can be deposited into an account indicated by the borrower. The second amount of money can be deposited in response to an interaction between the lender server and an account server that has access to the borrower's account (e.g., a bank).

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a possible loan providing system.

FIG. 2 is a schematic of a possible method for providing a loan.

### DETAILED DESCRIPTION

The following discussion describes a computer based loan processing system that employs various computing devices including servers, interfaces, systems, databases, or other types of computing devices. One should appreciate the computing devices comprise a processor configured to execute software instructions stored on a computer readable storage medium (e.g., hard drive, RAM, flash, ROM, etc.). The software instructions preferably configure the computing device to provide the roles, responsibilities, or other functionality as discussed below with respect to the specific apparatus. In an especially preferred embodiments, the various servers, systems, databases, or interfaces exchange data using standardized protocols or algorithms possibly based on HTTP, HTTPS, AES, public-private key exchanges, web service APIs, known financial transaction protocols, or other electronic information exchanging methods.

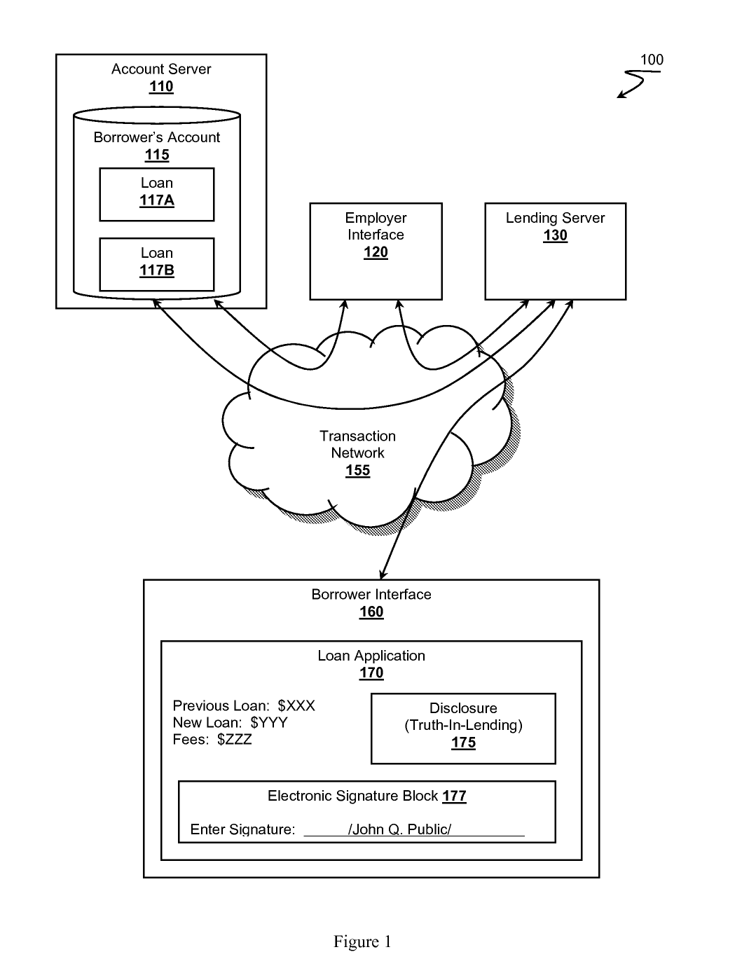

In FIG. 1, loan providing system 100 can comprise account server 110, employer interface 120, lender server 130, transaction network 155, and borrower interface 160.

A borrower can use loan providing system 100 to obtain multiple, serial loans 117A and 117B in a manner that simulates rolling over a short term loan. Preferably, a lender provides the borrower a first loan for an initial amount of money as represented by loan 117A.

The lender can utilize one or more of lender server 130 to interact with other members of the loan providing system 100. For example, lender server 130 can configure borrower interface 160 to present loan application 170 to a borrower over transaction network 155. Lender server 130 can also be configured to interact with account server 110, possibly operated by a bank, to deposit loans 117A and 117B into borrower's account 115. Lender server 130 can also be configured to interact with an employer, possibly through employer interface 120, to receive a payback amount for loans 117A or 117B, preferably through a payroll deduction.

The borrower can fill out a new loan application 170 for a second loan 117B that preferably includes a pre-authorization for an EFT and the borrower can execute loan application 170 using an electronic signature placed in electronic signature block 177. Lender server 130 can obtain the executed electronic signature block 177 and application 170 before payback of the initial loan 117A. When lender server 130 receives a payback amount for the initial loan 117A via an interaction with an employ through employer interface 120 or via an interface action with account server 110, the lender can quickly provide second loan 117B to the borrower, preferably by depositing loan 117B into borrower's account 115. In a preferred embodiment, new loan application 170 is approved before receiving the payback amount to decrease the delay between receiving the payback of first loan 117A and providing the borrower with the money from the new, second loan 117B. Use of electronic signatures in the new loan application 170 and for a pre-authorization of an EFT allows the borrower to obtain the benefits of a roll over without requiring the borrower to visit a brick and mortar store front. Rather, the borrower can engage the lender over transaction network 155, possibly the Internet, phone system, or other network capable of supporting a loan transaction.

In a preferred embodiment, the loan amounts for loans 117A and 117B are no greater than $500, or more preferably no greater than $300. The loan amounts provided to the borrower can include a requested amount of the loan less any finance charges. In some embodiments, the loan amounts for first loan 117A and second loan 117B are for the same amount.

Electronic signatures in electronic signature block 177 preferably represent legally binding signatures that can be transmitted electronically. Preferred electronic signatures conform to a federal law or regulation, including the Electronic Signatures in Global and National Commerce Act of 2000. In more preferred embodiments, an electronic signature includes an S-Signature. In other embodiments, an electronic signature can utilize third party e-signature services, possibly including EchoSign™. It is also contemplated that an electronic signature can comprise a digital signature in the form of a digital certificate, a public or a private key, an image of a signature, biometrics, or other digital means for representing a borrower's identification.

When a borrower wishes to obtain an additional loan 117B to effectively roll over first loan 117A, the borrower fills out new electronic loan application 170 designating a desired amount. Application 170 can provide details of loan 117A, loan 117B, or applicable fees. Application 170 could have data fields that are blank to be filed out by the borrower via borrower interface 160. More preferably, the data fields are pre-filled, where lender server 130 has automatically filled a substantial number of the data fields of application 170 based on previously submitted data. The notable exception is that signature block 177 remains blank so that a borrower can enter their electronic signature. At least one signature block 177 can include a pre-authorization for an EFT. The borrower simply enters their electronic signature in new application 170 and sends new application 170 back to lender server 130 via an electronic transmission (e.g., web posting, email, FAX, etc . . . ) over transaction network 155, preferably the Internet. Preferred new loan applications 170 also include a Truth-In-Lending Act disclosure 175 that details the payments and annual percentage rates of the loan for proper compliance with applicable laws.

Preferred loans 117A and 117B are short term loans having terms less than 31 days, or even less than 15 days. The terms of the loans are preferably commensurate with or less than the borrower's pay periods. The borrower should payback the loan, preferably in full, by the next payday. The payback amount can be the full amount of loan 117A or the full amount less any finance charges in situations where the finance charges have been deducted from the requested loan amount. In some embodiments, lender server 130 coordinates with the borrower's employer via employer interface 120 to deduct the payback amount from the borrower's pay check. The employer sends the funds, possibly through an EFT through employer interface 120, to the lender to ensure the loan is paid back in full in a timely fashion.

In a preferred embodiment the lender is able to turn around a new loan quickly, preferably less than one week, to simulate a loan roll over. In more preferred embodiments, new application 170 for second loan 117B is pre-approved and second loan 117B is provided to the borrower in less than 24 hours of receiving the payback for initial loan 117A, where loan 117B is deposited into borrower's account 115. In a yet more preferred embodiment, second loan 117B is provided to the borrower at substantially the same time (e.g., within one hour) of receiving the payback for the initial loan. The lender can simply perform an EFT to transfer the amount of the second loan to account 115 designated by the borrower. Lending server 130 preferably interacts with account server 110 to ensure the funds are properly transferred.

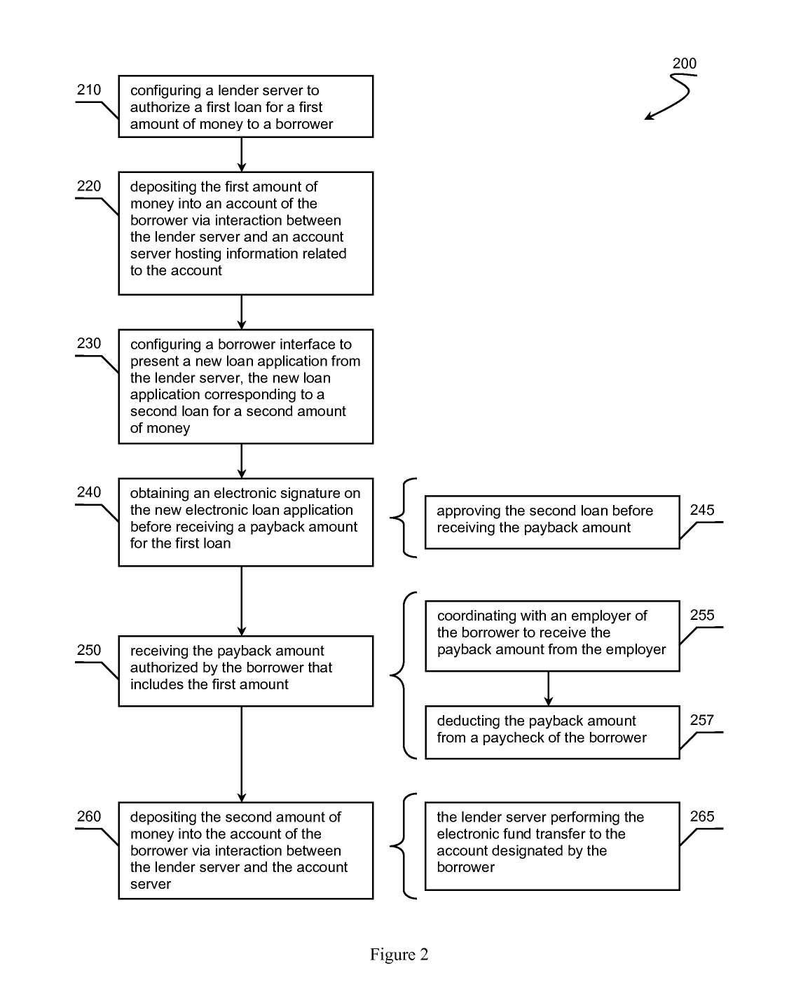

In FIG. 2, method 200 presents a possible method of providing a loan. One should appreciate that steps of method 200 can include interactions among computing devices of a transaction system as discussed with respect to FIG. 1. Furthermore, the computing devices of the transaction system can communicate with each other over a transaction network (e.g., the Internet).

Step 210 includes configuring a lender server to authorize a first loan for a first amount of money to a borrower. The initial loan can be authorized once a suitable loan application has been filled out by a borrower, possibly through a web-based borrower interface (e.g., a web browser) or possibly through a brick-and-mortar store front.

Step 220 can include depositing the first amount of money into an account of the borrower via interaction between a lender server and an account server, possibly a bank's server, hosting information related to the account. The interaction between the lender server and the account server can include authenticating the lender server, authorization the lender server or other activities required to conduct an EFT. One should appreciate that interaction can include any desired secure data exchanges as required by regulations or standards. It is also contemplated that the first amount of money deposited in the account could be less than an approved amount for the first loan. For example, fees could be deducted from the approved amount before depositing the remaining funds into the borrower's account.

Step 230 can include configuring a borrower interface to present a new loan application from the lender server, where the new loan application corresponds to a second loan for a second amount of money. In a preferred embodiment the lender server operates as a web server capable of configuring a borrower's computing device to render a presentation of the new loan application to the borrower. The new loan application could be rendered in a portable document formation (PDF), HTML, or other digital rendering formats. The borrower's interface could including a computer, a televisions, a cell phone, or other computing device configured to interact with a lender's servers over a network. It is also contemplated that the new loan application could be presented via a software application specifically written and deployed by a lender, an iPhone app for example. Preferably, the new loan application includes an electronic signature block.

Step 240 can include obtaining an electronic signature on a new electronic loan application before receiving a payback amount for the first loan. The electronic signature can be obtained over a transaction network (e.g., Internet, phone network, etc.) once the new loan application has been submitted to a lender via its lender server. Preferably, at step 245 the method includes approving the second loan before receiving the payback amount for the first amount of money for the first loan. Such an approach begins the simulation of rolling over the initial first loan. In a preferred embodiment, a borrower's electronic signature represents one or more authorizations for EFTs including paying the first loan back via a payroll deduction.

Step 250 can include receiving the payback amount of the first loan as authorized by the borrower via the electronic signature where the payback amount covers the amount of the first loan including applicable fees if necessary. Step 250 can further comprise step 255, which includes coordinating with an employer of the borrower to receive the payback amount of the first loan from the employer. For example, at step 257, receiving the payback amount can include the employer deducting the payback amount from a paycheck of the borrower.

Step 260 can include depositing the second amount of money into the borrower's designated account via an interaction between a lender server and an account server. In a particularly preferred embodiment, the lender server performs an ETF to the account at step 265. Thus, quickly funding of the account for the second loan simulates a roll over loan of the initial loan amount while also complying with regulations.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of providing a loan, the method comprising:
configuring a lender server to authorize a first loan for a first amount of money to a borrower;
depositing the first amount of money into an account of the borrower via interaction between the lender server and an account server hosting information related to the account;
configuring a borrower interface to present a new loan application from the lender server, the new loan application corresponding to a second loan for a second amount of money;
obtaining an electronic signature on the new electronic loan application before receiving a payback amount for the first loan;
receiving the payback amount authorized by the borrower that includes the first amount; and
depositing the second amount of money into the account of the borrower via interaction between the lender server and the account server.

2. The method of claim 1 wherein the first loan amount and the second loan amount are for the same amount.

3. The method of claim 1, wherein the first loan amount and the second loan amount are amounts no greater than $300.

4. The method of claim 1, wherein the step of obtaining the electronic signature is performed over a network.

5. The method of claim 1, wherein the step of receiving the payback includes deducting the payback amount from a paycheck of the borrower.

6. The method of claim 5, further comprising coordinating with an employer of the borrower to receive the payback amount from the employer.

7. The method of claim 1, wherein the step of providing the second loan occurs within one week of receiving the payback amount.

8. The method of claim 7, wherein the step of providing the second loan occurs within 24 hours of receiving the payback.

9. The method of claim 8, wherein the step of providing the second loan occurs substantially at the same time as receiving the payback.

10. The method of claim 1, wherein the electronic signature pre-authorizes an electronic fund transfer of the second loan amount to the account designated by the borrower.

11. The method of claim 10, wherein the step of providing the second loan includes the lender server performing the electronic fund transfer to the account designated by the borrower.

12. The method of claim 1, wherein the electronic loan application comprises pre-filled fields and a blank signature block.

13. The method of claim 1, wherein the first loan amount is a desired amount less a finance charge.

14. The method of claim 1, wherein the loan application includes a Truth-In-Lending Act disclosure.

15. The method of claim 1, wherein the term for the second loan is no greater than 31 days.

16. The method of claim 14, wherein the term for the second loan is no greater than 15 days.

17. The method of claim 1, further comprising approving the second loan before receiving the payback amount.
